(19) United States
(12) Patent Application Publication
(10) Pub. No.: US 2021/0258076 A1
(43) Pub. Date: Aug. 19, 2021

(54) HYBRID FIBER/COAXIAL TAPS, AND RELATED METHODS AND NETWORKS

(71) Applicant: Corning Optical Communications LLC, Charlotte, NC (US)

(72) Inventor: Gavriel Magnezi, Patah Tikva (IL)

(21) Appl. No.: 17/313,112

(22) Filed: May 6, 2021

Related U.S. Application Data
(63) Continuation of application No. PCT/US2019/058290, filed on Oct. 28, 2019.
(60) Provisional application No. 62/767,600, filed on Nov. 15, 2018.

(51) Int. Cl. H04B 10/2575; H01R 31/06; H01R 31/02; G02B 6/42

(52) U.S. Cl. CPC H04B 10/2575; H01R 31/065; H01R 2201/24; G02B 6/4206; H01R 2201/04; H01R 31/02

(57) ABSTRACT

Hybrid fiber/coaxial (coax) taps, and related methods and networks. The hybrid fiber/coax tap is configured to receive and convert downlink optical RF signals from a downlink distribution optical fiber to downlink electrical RF signals to be split and distributed to coax taps. Subscriber coax cables can be connected to the coax taps to “tap” the downlink electrical RF signals to subscribers. The hybrid fiber/coax tap is also configured to convert received uplink electrical RF signals on the coax taps into uplink optical RF signals to be distributed over an uplink distribution optical fiber connected to the output optical port. The hybrid fiber/coax tap also includes an input coax port configured to be connected to a coax distribution cable to receive a power signal from a coax network for powering fiber optic components. Electrical RF signals received on the coax port are passed on an output coax port to downstream taps.

### CROSS-REFERENCE TO RELATED APPLICATIONS

This application is a continuation of International Application No. PCT/US2019/058290 filed on Oct. 28, 2019, which claims the benefit of priority under 35 U.S.C. § 119 of U.S. Provisional Application Ser. No. 62/767,600, filed Nov. 15, 2018, the content of each of which is relied upon and incorporated herein by reference in their entirety.

### BACKGROUND

This disclosure generally relates to coaxial (coax) taps (i.e., directional couplers), such as a cable television (CATV) tap, supporting coax cable connectivity for tapping an available signal and power distributed over a coax distribution cable. This disclosure particularly relates to upgrading a coax tap to provide a hybrid fiber/coax tap supporting fiber optic distribution cable connectivity for optical signal tapping and also supporting legacy coax distribution cable connectivity in an existing coax cable infrastructure for tapping power distributed over the coax distribution cable.

Communications and data networks can employ fiber optic and coax cables for data signal and power signal distribution. In this regard, FIGS. 1A and 1B illustrate an exemplary network 100 configured to distribute communications and/or other data signals to subscribers. The network may be a CATV network that distributes CATV signals as an example. As shown in FIG. 1A, the network 100 is split between a fiber optic segment 102F and a coax segment 102C. In this regard, this example includes switching points 104 that are configured to distribute optical signals over a distribution network 106 comprised of fiber optic feeder cables 108. The benefits of optical fiber are well known and include higher signal-to-noise ratios and increased bandwidth. The switching points 104 include optical line terminals (OLTs) or forward lasers/return receivers 110 that convert electrical radio frequency (RF) signals to and from optical signals. The optical signals may then be carried over the fiber optic feeder cables 108 to local convergence points (LCPs) 112. The LCPs 112 act as consolidation points for splicing and making cross-connections and interconnections, as well as providing locations for optical couplers and splitters. The optical couplers and splitters in the LCPs 112 enable a single optical fiber to serve multiple subscriber premises 114. Typical subscriber premises 114 include single-dwelling units (SDU), multi-dwelling units (MDU), businesses, and/or other facilities or buildings. Fiber optic cables 116, such as distribution cables, exit the LCPs 112 to carry optical signals to hybrid fiber-coax (HFC) nodes 118 that are configured to convert optical signals received over the fiber optic cables 116 to electrical signals. For example, the electrical signals may be distributed over coax drop cables 120 that are run to the subscriber premises 114. The network 100 is configured to as coax-to-the-premises (also known as the “last mile”) to avoid the additional expense of running optical fiber all the way to the subscriber premises 114.

FIG. 1B illustrates additional exemplary detail of the distribution of the electrical signals from an HFC node 118 to a subscriber premise 114 in the network 100 of FIG. 1A. As shown in FIG. 1B, coax taps 122 are coupled inline to a coax drop cable 120 to tap the electrical signals carried over the coax drop cable 120 to subscriber premises 114. An amplifier 124 can also be connected inline to the coax drop cable 120 to amplify the electrical signals carried on the coax drop cable 120 carried downstream towards subscriber premises 114. The amplifier 124 is a circuit that requires power for operation. In this regard, the amplifier 124 is powered through an alternating current (AC) power signal that is also carried on the coax drop cable 120 and passes through the coax taps 122. The amplifier 124 includes an AC to direct current (DC) (AC-DC) converter circuit to convert the AC power signal (e.g., up to 15 Amperes (Amps)) to a DC power signal for powering circuits therein. Subscriber coax cables 126 are connected to the coax taps 122 to carry the electrical signals from the coax drop cable 120 to the subscriber premises 114.

FIGS. 2A and 2B illustrate a coax tap 122 in more detail. FIG. 2A is a diagram of the coax tap 122, and FIG. 2B is a circuit diagram of the coax tap 122. As shown in FIG. 2A, the coax tap 122 includes an enclosure 200 that supports a distribution-side coax connector 202 and a subscriber-side coax connector 204 that are configured to connect to coax connectors 206, 208 of a respective upstream coax drop cable 120U and a downstream coax drop cable 120D. The coax tap 122 also includes tap coax connectors 210(1)-210(8) that are electrically coupled to the distribution-side coax connector 202 to couple split electrical signals from the coax drop cable 120 to subscriber coax cables 126 (see FIG. 1B) connected between tap coax connectors 210(1)-210(8) and equipment at the subscriber premises 114. In this regard, as shown in FIG. 2B, the coax tap 122 includes a bridge circuit 212 that carries electrical signals received through the distribution-side coax connector 202 to the subscriber-side connector 204 to the downstream coax drop cable 120D to be carried to further coax taps 122 and/or subscriber premises 114. The bridge circuit 212 includes a coupler circuit 214 that filters out the AC power signal on the distribution-side coax connector 202. The coupler circuit 214 is coupled to a splitter/combiner circuit 216 that split/combines the electrical RF signal from the distribution-side coax connector 202, to and from the tap coax connectors 210(1)-210(8). The bridge circuit 212 also includes an RF choke 218 that filters out the electrical RF signals on the distribution-side coax connector 202 to provide the AC power signal to the subscriber-side coax connector 204 to be carried by the downstream coax drop cable 120D to a next downstream coax tap 122. The coax tap 122 also includes tap coax connectors 210(1)-210(8) that are electrically coupled to the distribution-side coax connector 202.

The bandwidth of the electrical RF signal supported by the coax tap 122 in FIGS. 2A and 2B is limited to approximately 1.2 GigaHertz (GHz), because the RF choke 218 that isolates the electrical RF signals from the AC power signal is bandwidth limited.

No admission is made that any reference cited herein constitutes prior art. Applicant expressly reserves the right to challenge the accuracy and pertinency of any cited documents.

### SUMMARY

Embodiments disclosed herein include hybrid fiber/coaxial (coax) taps. Related methods and networks employing the hybrid fiber/coax taps are also disclosed. A hybrid fiber/coax tap can be employed in a fiber optic network to support fiber optic connectivity for exchanging radio frequency (RF) optical signals to and from the network. The hybrid fiber/coax taps includes coax taps so that subscriber tapping is in the electrical domain to remain backwards compatible with an installed subscriber coax network. In this manner, the hybrid fiber/coax tap facilitates sourcing of optical RF signals for lower noise and increased bandwidth while still preserving the legacy subscriber coax network. In exemplary aspects, the hybrid fiber/coax tap includes an input optical port(s) configured to receive downlink optical RF signals from a connected downlink distribution optical fiber. The hybrid fiber/coax tap includes an optical-to-electrical (O-E) converter circuit configured to convert the received downlink optical RF signals to downlink electrical RF signals to be split and distributed to coax taps (e.g., coax connectors) included in the hybrid fiber/coax tap. In examples disclosed herein, the hybrid fiber/coax tap passes the RF signals in analog form without performing signal processing of the RF signals. Subscriber coax cables can be connected to the coax taps of the hybrid fiber/coax tap to “tap” the downlink electrical RF signals to subscribers. The hybrid fiber/coax tap also includes an electrical-to-optical (E-O) converter circuit configured to convert the uplink electrical RF signals received on the coax taps from subscriber coax cables, into uplink optical RF signals. The uplink optical RF signals are coupled to an output optical port(s) in the hybrid fiber/coax tap to be distributed over an uplink distribution optical fiber connected to the output optical port.

In certain exemplary aspects, to provide power to the O-E and E-O converter circuits of the hybrid fiber/coax taps as power-consuming circuits to power their operation, the hybrid fiber/coax tap includes an input coax port and an output coax port in a base enclosure. The input coax port is configured to be connected to an upstream coax distribution cable that carries electrical RF signals and a power signal as part of a coax network (e.g., a cable television (CATV) network). The output coax port is configured to be connected to a downstream coax distribution cable to further distribute the electrical RF signals and power signal to other connected downstream taps and/or subscriber equipment. The hybrid fiber/coax tap includes a filter circuit (e.g., an RF choke) that is coupled to the input coax port to pass a power signal from the upstream coax distribution cable to a power supply that is configured to supply power to the O-E and E-O converter circuits. Because the hybrid fiber/coax tap has fiber optic connectivity for receiving and distributing optical RF signals converted to electrical RF signals between the network and subscribers connected to the coax taps, the hybrid fiber/coax tap does not tap the electrical RF signals received on the input coax port. However, the hybrid fiber/coax tap is still configured to receive and distribute the received electrical RF signals from the input coax port to the output coax port so that other downstream taps connected to the output coax port of the hybrid fiber/coax tap can still receive the electrical RF signals and power signal. For example, such other downstream taps may be legacy coax taps that do not support fiber optic connectivity and are instead configured to tap the electrical RF signals from a connected coax distribution cable to be distributed to their respective coax tap connectors.

Further, in other exemplary aspects, to facilitate the installation of the hybrid fiber/coax tap in an existing coax network, the hybrid fiber/coax tap includes a face plate. The face plate is removably attached to the base enclosure of a coax tap. The input and output optical ports and the O-E and E-O converter circuits that facilitate fiber optic connectivity are included as part of a face plate of the hybrid fiber/coax tap. The input and output coax ports are included in the base enclosure. Thus, to convert an existing coax tap to a hybrid fiber/coax tap in an existing network, the face plate of an existing coax tap can be removed from its base enclosure and replaced with the face plate of the hybrid fiber/coax tap. The base enclosure is equipped with a coupling circuit that is configured as a make-before-break circuit to short circuit the input and output coax ports when the face plate is removed. This provides continued distribution of the electrical RF signals and power signal to other downstream taps when the face plate is removed, because the input and output coax ports are part of the base enclosure and not the removable face plate. The face plate of the hybrid fiber/coax tap includes the filter circuit that is configured to be coupled to the input coax port when the face plate is attached to the base enclosure to couple the power signal from the input coax port to the power consuming circuits of the hybrid fiber/coax tap for their operation. In this manner, the hybrid fiber/coax tap can be installed in an existing coax network with affecting other legacy coax taps receiving and distributing electrical RF signals and the power signal in the coax network.

Further, in certain exemplary aspects, the face plate of the hybrid fiber/coax tap also includes a bridge circuit that is configured to short circuit the input and output coax ports in the base enclosure when the face plate is installed on the base enclosure. In this manner, as previously described, the electrical RF signals and power signal carried on coax distribution cables connected to the input and output coax ports are uninterrupted even when the face plate of the hybrid fiber/coax tap is installed on the base enclosure. Even though the hybrid fiber/coax tap does not couple the electrical RF signals carried on coax distribution cables connected to the input and output coax ports of its base enclosure, other taps connected to the input and output coax ports of the hybrid fiber/coax tap may be legacy coax taps that do source the electrical RF signals from a coax distribution cable.

In this regard, in one exemplary aspect, a hybrid fiber/coax tap is provided. The hybrid fiber/coax tap comprises a downlink input optical port configured to be connected to a downlink optical fiber carrying an optical radio frequency (RF) signal. The hybrid fiber/coax tap also comprises an uplink input optical port. The hybrid fiber/coax tap also comprises an O-E converter circuit coupled to the downlink input optical port, the O-E converter circuit configured to convert a downlink optical RF signal into a downlink electrical RF signal. The hybrid fiber/coax tap also comprises a plurality of coax tap ports. The hybrid fiber/coax tap also comprises an electrical splitter circuit coupled to the O-E converter circuit and the plurality of coax tap ports, the electrical splitter circuit configured to split the downlink electrical RF signal into a plurality of the downlink electrical RF signals each distributed on a coax tap port among the plurality of coax tap ports. The hybrid fiber/coax tap also comprises an electrical combiner circuit coupled to the plurality of coax tap ports and an E-O converter circuit, the electrical combiner circuit configured to combine a plurality of uplink electrical RF signals received on the plurality of coax tap ports into a combined uplink electrical RF signal. The E-O converter circuit is coupled to the electrical combiner circuit and the uplink input optical port, the E-O converter circuit configured to convert the combined uplink electrical RF signal to a combined uplink optical RF signal. The uplink input optical port is configured to receive the combined uplink optical RF signal. The hybrid fiber/coax tap also comprises an input coax port configured to be connected to an upstream coax distribution cable carrying an electrical RF signal and a power signal. The hybrid fiber/coax tap also comprises an output coax port coupled to the input coax port and configured to be connected to a downstream coax distribution cable to distribute the electrical RF signal and the power signal to the downstream coax distribution cable. The hybrid fiber/coax tap also comprises a filter circuit coupled to the input coax port, the O-E converter circuit, and the E-O converter circuit, the filter circuit configured to filter the electrical RF signal to couple the power signal to the O-E converter circuit and the E-O converter circuit.

An additional aspect of the disclosure relates to a hybrid fiber/coax tap. The hybrid fiber/coax tap comprises a base enclosure. The hybrid fiber/coax tap also comprises a face plate configured to be removably attached to the base enclosure. The base enclosure comprises an input coax port, an output coax port, and a coupling circuit configured to couple the input coax port to the output coax port when the face plate is detached from the base enclosure. The face plate comprises a downlink input optical port and an uplink input optical port. The face plate also comprises an O-E converter circuit coupled to the downlink input optical port. The face plate also comprises a plurality of coax tap ports. The face plate also comprises an electrical splitter circuit coupled to the O-E converter circuit and the plurality of coax tap ports. The face plate also comprises an electrical combiner circuit coupled to the plurality of coax tap ports and an E-O converter circuit. The E-O converter circuit is coupled to the electrical combiner circuit and the uplink input optical port. The face plate also comprises a filter circuit coupled to the O-E converter circuit and the E-O converter circuit. The face plate also comprises a bridge circuit coupled to the filter circuit, the bridge circuit configured to be coupled to the input coax port to the output coax port when the face plate is attached to the base enclosure.

An additional aspect of the disclosure relates to a method of installing a hybrid fiber/coax tap. The method comprises removing a face plate from a base enclosure such that a coupling circuit of the base enclosure makes a first connection of an input coax port of the base enclosure to an output coax port of the base enclosure. The method also comprises attaching a hybrid fiber/coax face plate to the base enclosure such that a bridge circuit of the hybrid fiber/coax face plate makes a second connection of the input coax port to the output coax port.

An additional aspect of the disclosure relates to a network. The network comprises at least one coax tap each comprising an input coax port configured to be connected to an upstream coax distribution cable carrying a power signal and an electrical RF signal, an output coax port configured to be connected to a downstream coax distribution cable, and a plurality of coax tap ports. Each of the at least one coax taps is configured to distribute the electrical RF signal to the plurality of coax tap ports and distribute the power signal and the electrical RF signal from the input coax port to the output coax port. The network also comprises at least one hybrid fiber/coax tap. Each of the at least one hybrid fiber/coax taps comprises a base enclosure, and a hybrid fiber/coax face plate configured to be removably attached from the base enclosure. The base enclosure comprises a second input coax port configured to be connected to a second upstream coax distribution cable carrying the power signal and the electrical RF signal. The base enclosure also comprises a second output coax port configured to be connected to a second downstream coax distribution cable. The base enclosure also comprises a coupling circuit configured to couple the second input coax port to the second output coax port and distribute the power signal and the electrical RF signal from the second input coax port to the second output coax port when the hybrid fiber/coax face plate is detached from the base enclosure. The hybrid fiber/coax face plate comprises a downlink input optical port, an uplink input optical port, an O-E converter circuit coupled to the downlink input optical port, a plurality of second coax tap ports, an electrical splitter circuit coupled to the O-E converter circuit and the plurality of second coax tap ports, an electrical combiner circuit coupled to the plurality of second coax tap ports and an E-O converter circuit. The E-O converter circuit is coupled to the electrical combiner circuit and the uplink input optical port. The hybrid fiber/coax face plate also comprises a filter circuit coupled to the O-E converter circuit and the E-O converter circuit, and a bridge circuit coupled to the filter circuit, the bridge circuit configured to be coupled to the second input coax port to the second output coax port when the face plate is attached to the base enclosure.

Additional features and advantages will be set forth in the detailed description which follows and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding of the disclosure, and are incorporated in and constitute a part of this specification. The drawings illustrate one or more embodiment(s), and together with the description serve to explain principles and operation of the various embodiments.

### BRIEF DESCRIPTION OF THE DRAWINGS

FIGS. 1A and 1B are schematic diagrams of an exemplary hybrid fiber/coaxial (coax) tap network for distributing communications and/or data signals to subscriber premises;

FIGS. 2A and 2B are a respective schematic and circuit diagram of an exemplary coax tap configured to support inline connection to a coax drop cable and coax tap connectors for connecting coax subscriber cables to support distribution of the electrical signals carried on the coax drop cable to a subscriber premise;

FIG. 3 is a schematic diagram of an exemplary hybrid fiber/coax tap in a network, wherein the hybrid fiber/coax tap supports fiber optic distribution cable connectivity for receiving distributed optical communications and/or data signals over a high bandwidth optical fiber that is converted in conversion circuitry into electrical signals coupled to coax taps to be “tapped” to subscriber premises, and also supports legacy coax distribution cable connectivity for receiving a power signal coupled to power the conversion circuitry and also bridged to an output coax port to be further distributed downstream;

FIGS. 4A-4C are front, front perspective, and rear perspective views, respectively, of the hybrid fiber/coax tap in the network in FIG. 3;

FIG. 5 is a rear view of the hybrid fiber/coax tap in FIGS. 4A-4C with the internal components of the face plate shown;

FIG. 6 is an exemplary circuit diagram that can be employed in the hybrid fiber/coax tap in FIGS. 4A-5;

FIG. 7A is a bottom view of the face plate of the hybrid fiber/coax tap in FIGS. 4A-5;

FIG. 7B is a bottom view of the face plate installed on the base enclosure of the hybrid fiber/coax tap in FIGS. 4A-5;

FIG. 7C is a bottom view of another exemplary face plate that can be employed in the hybrid fiber/coax tap in FIGS. 4A-5;

FIGS. 8A and 8B are front perspective and rear perspective views, respectively, of an alternative hybrid fiber/coax tap that additionally includes an output optical port for passing and receiving optical signals downstream from the hybrid fiber/coax tap in a daisy-chain configuration;

FIG. 9 is a rear view of the hybrid fiber/coax tap in FIGS. 8A and 8B with the internal components shown;

FIG. 10 is an exemplary circuit diagram that can be employed in the hybrid fiber/coax tap in FIGS. 8A-9 that additionally includes an output optical port for passing and receiving optical signals downstream from the hybrid fiber/coax tap in a daisy-chain configuration;

FIG. 11 is an alternative, exemplary circuit diagram that can be employed in the hybrid fiber/coax tap in in FIGS. 8A-9 that additionally includes an output optical port for passing and receiving optical signals downstream from the hybrid fiber/coax tap in a daisy-chain configuration;

FIG. 12 is a schematic diagram of an exemplary network that can employ hybrid fiber/coax taps, including but not limited to the hybrid fiber/coax tap in FIGS. 4A-11, to distribute communications and/or data signals to subscriber premises; and

FIG. 13 is a flowchart illustrating an exemplary process of installing a hybrid fiber/coax tap in a network by converting an existing coax tap connected into the network to a hybrid fiber/coax tap.

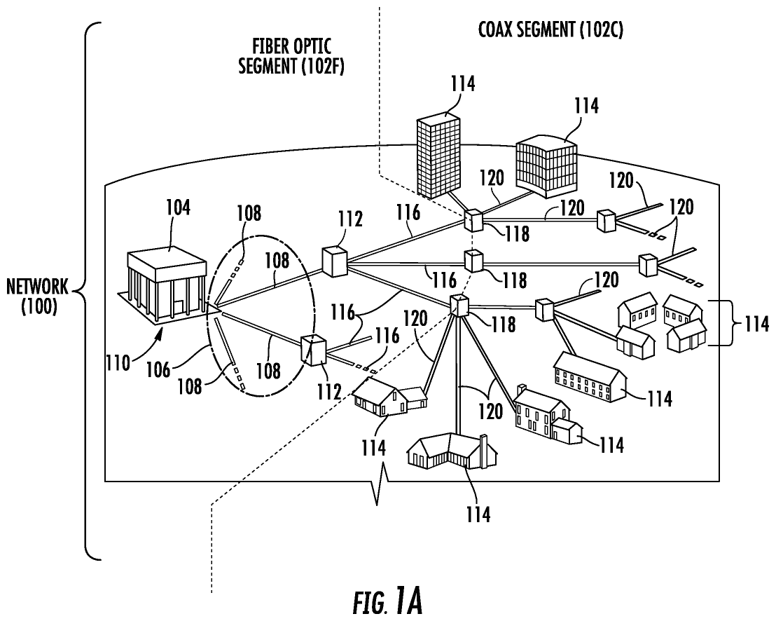

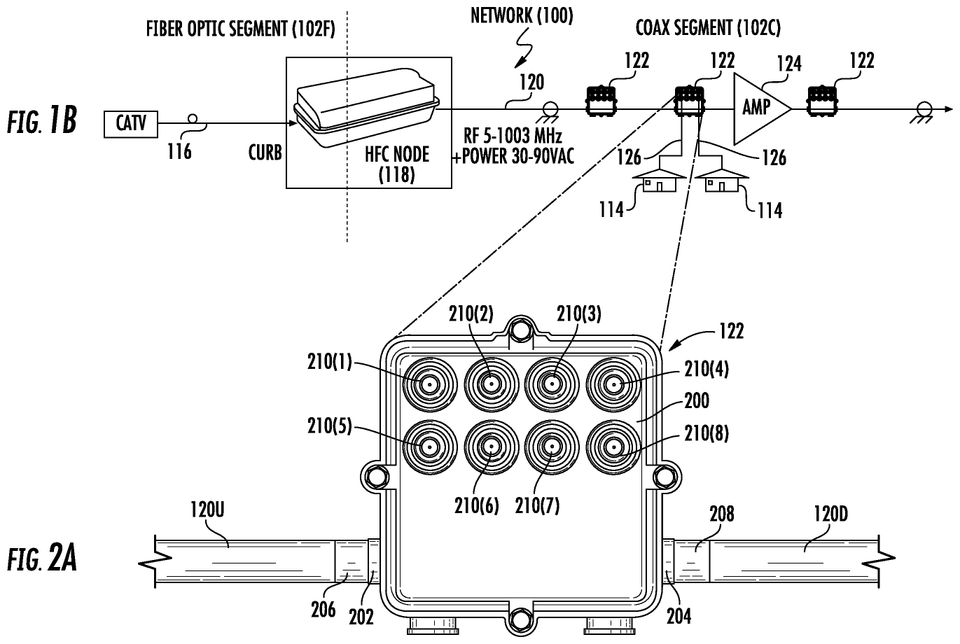

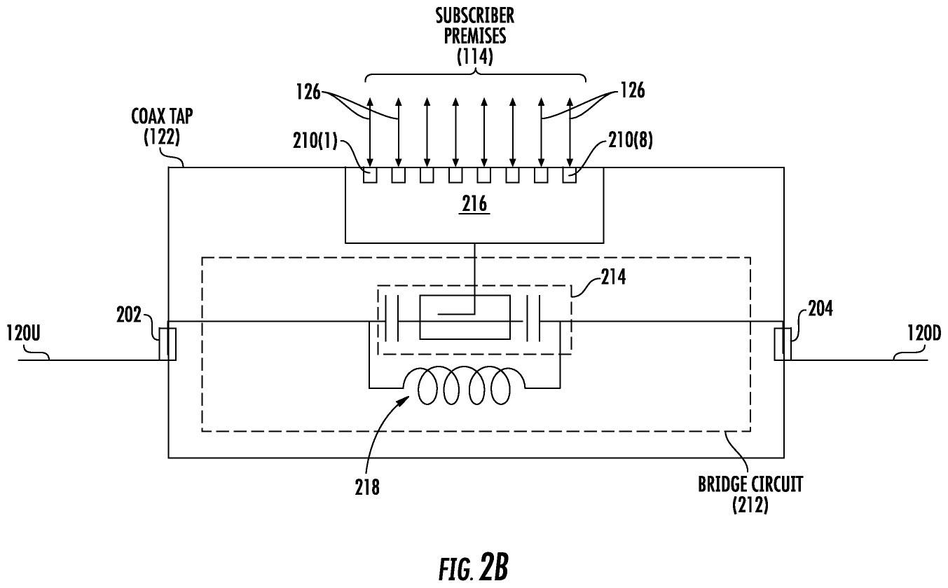

### DETAILED DESCRIPTION

Embodiments disclosed herein include hybrid fiber/coaxial (coax) taps. Related methods and networks employing the hybrid fiber/coax taps are also disclosed. A hybrid fiber/coax tap can be employed in a fiber optic network to support fiber optic connectivity for exchanging radio frequency (RF) optical signals to and from the network. The hybrid fiber/coax taps includes coax taps so that subscriber tapping is in the electrical domain to remain backwards compatible with an installed subscriber coax network. In this manner, the hybrid fiber/coax tap facilitates sourcing of optical RF signals for lower noise and increased bandwidth while still preserving the legacy subscriber coax network. In exemplary aspects, the hybrid fiber/coax tap includes an input optical port(s) configured to receive downlink optical RF signals from a connected downlink distribution optical fiber. The hybrid fiber/coax tap includes an optical-to-electrical (O-E) converter circuit configured to convert the received downlink optical RF signals to downlink electrical RF signals to be split and distributed to coax taps (e.g., coax connectors) included in the hybrid fiber/coax tap. In examples disclosed herein, the hybrid fiber/coax tap passes the RF signals in analog form without performing signal processing of the RF signals. Subscriber coax cables can be connected to the coax taps of the hybrid fiber/coax tap to “tap” the downlink electrical RF signals to subscribers. The hybrid fiber/coax tap also includes an electrical-to-optical (E-O) converter circuit configured to convert the uplink electrical RF signals received on the coax taps from subscriber coax cables, into uplink optical RF signals. The uplink optical RF signals are coupled to an output optical port(s) in the hybrid fiber/coax tap to be distributed over an uplink distribution optical fiber connected to the output optical port.

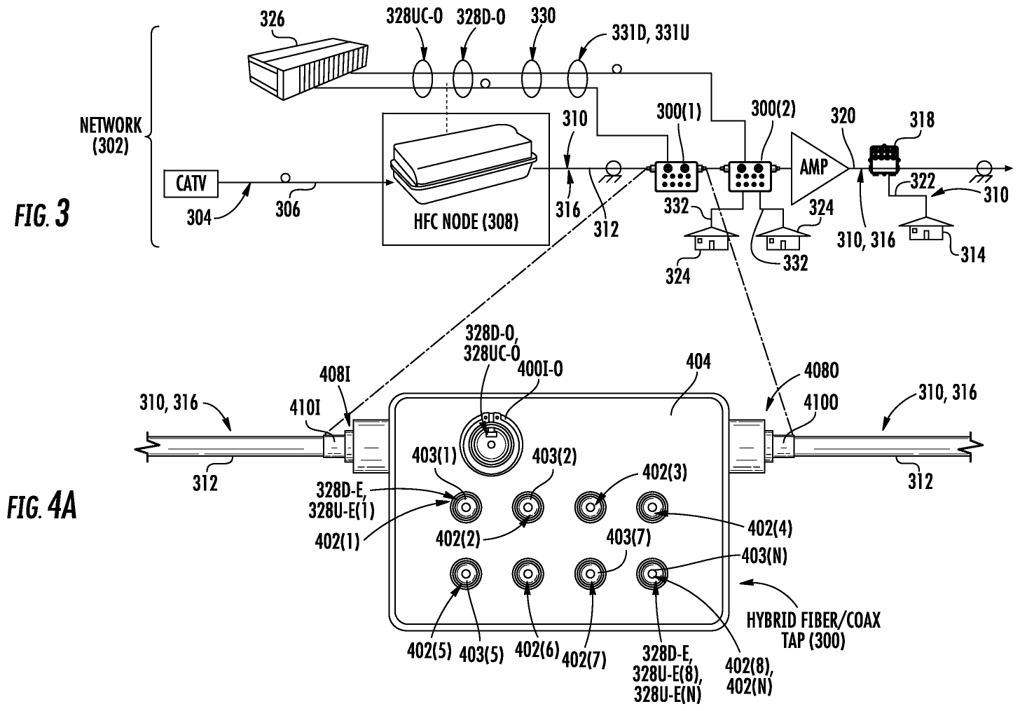

In this regard, FIG. 3 is a schematic diagram of exemplary hybrid fiber/coax taps 300(1), 300(2) employed in a network 302 to support the distribution of communications and/or data signals to subscribers. In this example, the network 302 is a cable television (CATV) network where RF signals in the form of optical RF signals 304 as CATV signals are distributed over a fiber optic distribution cable(s) 306 to network elements to be distributed to subscribers in the network 302. Optical fiber has known benefits of higher signal-to-noise ratios (SNR) and thus can support higher bandwidth signals. However, coax cable distribution may be employed to distribute RF signals in the network 302 to the subscribers, often called the “last mile” due, such as to maintain backwards compatibility to legacy coax network installations and/or cost reasons. In this regard, the network 302 in FIG. 3 includes a hybrid fiber-coax (HFC) node 308 connected to the fiber optic distribution cable(s) 306 that converts the optical RF signals 304 to electrical RF signals 310 to be distributed over a coax distribution cable(s) 312 (e.g., a RJ11 coax cable) to a subscriber 314. The HFC node 308 is also configured to inject a power signal 316 (e.g., a 60 Hz signal) onto the coax distribution cable(s) 312 along with the electrical RF signals 310 to provide a supply of power to a coax tap 318 on the network 302. The coax tap 318 is configured to split the received electrical RF signals 310 from a coax distribution cable 320 onto a coax tap connector in which a subscriber coax cable 322 (e.g., a RJ11 coax cable) can be connected to distribute the electrical RF signals 310 to the subscriber 314. The coax tap 318 can include a filter circuit that filters the power signal 316 from the electrical RF signals 310. The bandwidth of electrical RF signals 310 in the network 302 distributed over the coax distribution cable(s) 306 may be limited (e.g., 1.2 GigaHertz (GHz) or less) below the bandwidth capabilities of the fiber optic distribution cable(s) 306 due to cable losses and/or the isolation capabilities of filter circuits in network elements used to filter the power signal 316 from the electrical RF signals 310. However, it may be desired to provide higher bandwidth data services (e.g., up to 3.0 GHz) to subscribers in the network 302 in FIG. 3 that includes the legacy coax distribution cable(s) 312.

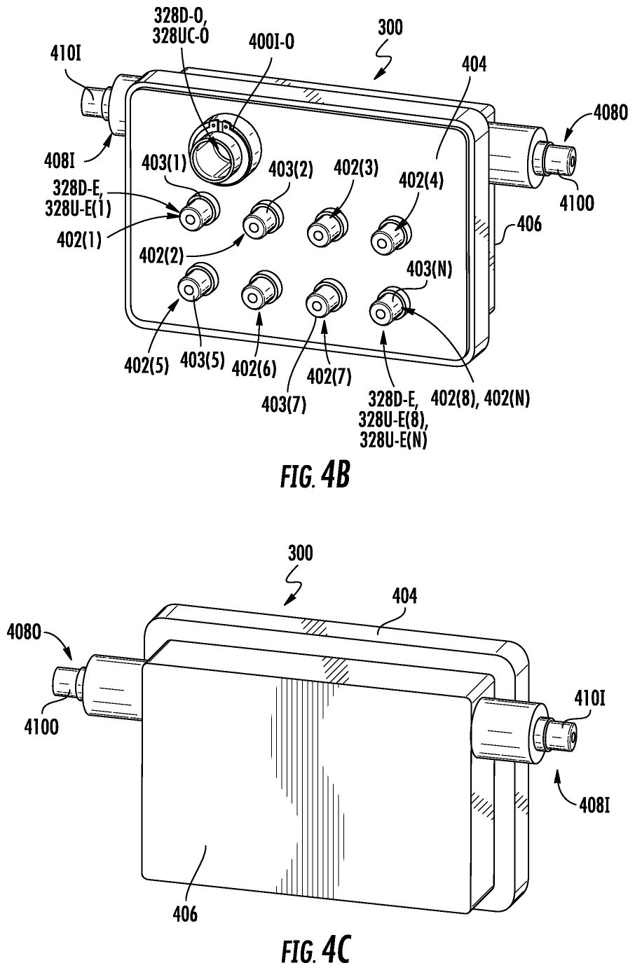

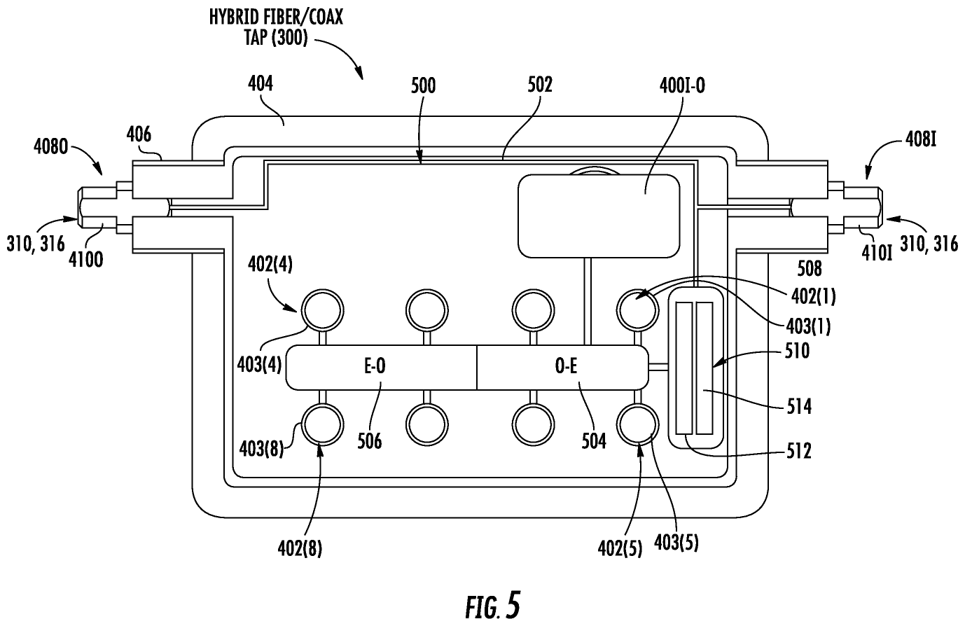

In this regard, as shown in FIG. 3, the hybrid fiber/coax taps 300(1), 300(2) can also be employed in the network 302 to support distribution of downlink optical RF signals 328D-O at higher bandwidths to support higher bandwidth communications and/or data services to subscribers 324. The network 302 in FIG. 3 includes fiber optic distribution equipment 326 that distributes downlink optical RF signals 328D-O over connected fiber optic distribution cables 330. As shown in FIG. 3 and in a more detailed diagram of a hybrid fiber/coax tap 300 in FIG. 4A that are the hybrid fiber/coax taps 300(1), 300(2) in FIG. 3, the hybrid fiber/coax tap 300 includes an input optical port 400I-O that is configured to be connected to a downlink optical fiber 331D in the fiber optic distribution cable 330 carrying the downlink optical RF signals 328D-O. The hybrid fiber/coax tap 300 is configured to convert the downlink optical RF signals 328D-O into downlink electrical RF signals 328D-E and split the converted downlink electrical RF signals 328D-E onto a plurality of coax tap ports 402(1)-402(N), where ‘N’ is eight (8) in this example supporting up to eight (8) different subscribers 314. The hybrid fiber/coax tap 300 in this example distributes the downlink electrical RF signals 328D-E in analog form without performing signal processing of the downlink optical or electrical RF signals 328D-O, 328D-E, unlike the HFC node 308, which includes signal processing circuitry to separate data from a communication protocol overhead (e.g., a DOCSIS signal). In this example, the coax tap ports 402(1)-402(N) are female coax connectors 403(1)-403(N). As shown in hybrid fiber/coax tap 300(2) in FIG. 3, subscriber coax cables 332 can be connected to coax tap ports 402(1)-402(N) on the hybrid fiber/coax tap 300(2) to distribute the converted downlink electrical RF signals 328D-E over subscriber coax cables 332 to the subscribers 324. Also, as shown in FIG. 4A, the hybrid fiber/coax tap 300 is configured to combine individual uplink electrical RF signals 328U-E(1)-328U-E(8), 328U-E(N) received over the subscriber coax cables 332 from the subscribers 324 over the coax tap ports 402(1)-402(N) into a combined uplink electrical RF signal 328UC-E that is converted into a combined uplink optical RF signal 328UC-O to be distributed over an uplink optical fiber 331U in the connected fiber optic distribution cable 330 to the fiber optic distribution equipment 326. In this manner, the hybrid fiber/coax tap 300 supports fiber optic connectivity in the network 302 in FIG. 3 as opposed to the coax tap 318 that only supports coax cable connectivity.

FIGS. 4B and 4C illustrate perspective front and rear perspective views of the hybrid fiber/coax tap 300 in FIG. 4A. As shown therein, the hybrid fiber/coax tap 300 includes a face plate 404 that supports the input optical port 400I-O and coax tap ports 402(1)-402(N). The face plate 404 is configured to be removably attached to a base enclosure 406 to provide an enclosed housing for the hybrid fiber/coax tap 300. As described in more detail below, while the hybrid fiber/coax tap 300 receives and distributes RF signals as downlink and combined uplink RF signals 328D-O, 328UC-O through the input optical port 400I-O as shown in FIGS. 4A-4C, as opposed to through coax ports over a coax cable, the hybrid fiber/coax tap 300 in this example still includes an input coax port 408I and output coax port 408O. The input coax port 408I and output coax port 408O are in the base enclosure 406 of the hybrid fiber/coax tap 300 and are female input and output coax connectors 410I, 410O in this example. The input coax port 408I is configured to be coupled to an upstream coax distribution cable 312 in the network 302 shown in FIGS. 3 and 4A to receive the electrical RF signals 310 and power signal 316, just as the coax tap 318 in FIG. 3 that does not support fiber optic connectivity. The output coax port 408O is configured to be coupled to a downstream coax distribution cable 312 in the network 302 shown in FIGS. 3 and 4A to receive the electrical RF signals 310 and power signal 316, just as the coax tap 318 in FIG. 3 that does not support fiber optic connectivity. Providing the input coax port 408I and output coax port 408O in the hybrid fiber/coax tap 300 allows the hybrid fiber/coax tap 300 to pass the electrical RF signals 310 and power signal 316 to the output coax port 408O so that another downstream coax tap connected to the output coax port 408O and that does not have fiber optic capability can receive and distribute the electrical RF signals 310 from the network 302 to its subscribed taps. Note that the electrical RF signals 310 and/or power signal 316 can be received on either the input coax port 408I or output coax port 408O. If received on the output coax port 408O, the hybrid fiber/coax tap 300 facilitates passing the electrical RF signals 310 and/or power signal 316 to the input coax port 408I so that another upstream coax tap is connected to the input coax port 408I.

This is shown in the rear view diagram of the hybrid fiber/coax tap 300 in FIG. 5 wherein a coupling circuit 500 in the form of a transmission line 502 is part of the base enclosure 406 and is connected between the input coax connector 410I of the input coax port 408I and the output coax connector 410O of the output coax port 408O. In this manner, the hybrid fiber/coax tap 300 can be connected into an existing subscriber coax network, such as in the network 302 of FIG. 3, without having to upgrade connected legacy coax taps. The coax distribution cables 312 do not have to be altered or changed. The face plate 404 of the hybrid fiber/coax tap 300 can be removed and attached to the base enclosure 406 without disturbing the connectivity of coax distribution cables 312 in the network 302 to the input coax connector 410I and output coax connector 410O, because the input coax connector 410I and output coax connector 410O are part of the base enclosure 406 in this example. If the hybrid fiber/coax tap 300 were not configured to still pass the electrical RF signals 310 from the coax distribution cable 312 downstream, downstream connected coax taps would not be able to source electrical RF signals 310 without a separate point-to-point coax cable, thereby adding additional cost and complexity to the network 302.

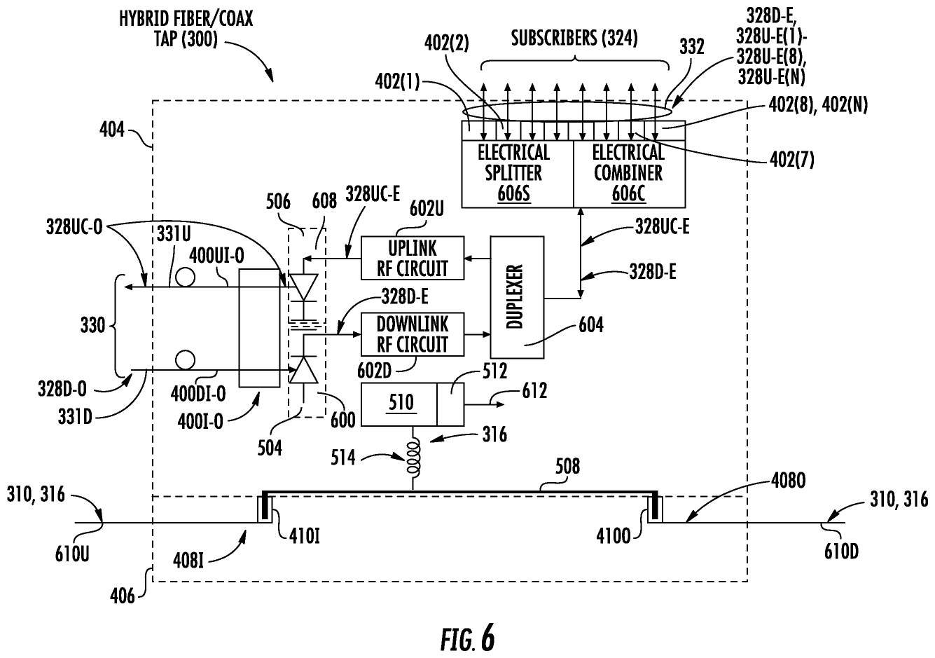

Further, providing the input coax port 408I in the hybrid fiber/coax tap 300 allows the hybrid fiber/coax tap 300 to receive the power signal 316 through the input coax port 408I. The power signal 316 can be coupled in the hybrid fiber/coax tap 300 as a source of power for power-consuming components in the hybrid fiber/coax tap 300. For example, as shown in the rear view of the hybrid fiber/coax tap 300 in FIG. 5, the face plate 404 of the hybrid fiber/coax tap 300 includes an optical-to-electrical (O-E) converter circuit 504 configured to convert the received downlink optical RF signals 328D-O from the downlink optical fiber 331D of the fiber optic distribution cable 330 (FIG. 4A) connected to the input optical port 400I-O to the downlink electrical RF signals 328D-E (FIG. 4A) distributed to the coax tap ports 402(1)-402(N). The hybrid fiber/coax tap 300 also includes an electrical-to-optical (E-O) converter circuit 506 configured to convert the combined uplink electrical RF signal 328UC-E (shown in FIG. 6) from the coax tap ports 402(1)-402(N) to the combined uplink optical RF signal 328UC-O (in FIG. 4A and FIG. 6) to be distributed to the input optical port 400I-O. The O-E converter circuit 504 and E-O converter circuit 506 require power for operation. So, as shown in FIG. 5, the face plate 404 in this example includes a bridge circuit 508 coupled to a power supply 510, which may be an alternating current (AC) to direct current (DC) (AC-DC) converter circuit 512 for example. The bridge circuit 508 is coupled to the input coax connector 410I of the input coax port 408I. The bridge circuit 508 is configured to couple the power signal 316 to the power supply 510, which is coupled to O-E converter circuit 504 and the E-O converter circuit 506, to provide power to the O-E converter circuit 504 and the E-O converter circuit 506 to power their operation. The power supply 510 may include a filter circuit 514, such as RF choke for example, that is configured to filter the electrical RF signals 310 from the power signal 316.

As discussed above, the input coax port 408I, and output coax port 408O, and the coupling circuit 500 are part of the base enclosure 406 of the hybrid fiber/coax tap 300. The input optical port 400I-O, the O-E converter circuit 504, the E-O converter circuit 506, the bridge circuit 508, the power supply 510, and the coax tap ports 402(1)-402(N) are part of the face plate 404 of the hybrid fiber/coax tap 300. In this manner, the face plate 404 of the hybrid fiber/coax tap 300 that supports the fiber optic connectivity can be removed without disconnecting the electrical RF signals 310 and power signal 316 distributed through the coupling circuit 500 to downstream components, such as other taps. The face plate 404 can also be designed such that it can be attached to the base enclosure of a legacy coax tap to upgrade the legacy coax tap to support fiber optic connectivity. This is again because the face plate 404 is designed to be compatible with the base enclosure 406 that includes the input coax port 408I, output coax port 408O, and coupling circuit 500. The coupling circuit 500 can be designed as a fixed, permanent short circuit between the input coax connector 410I to the output coax connector 410O. Alternatively, the coupling circuit 500 could be configured to as a make-before-break circuit that is configured to couple the input coax connector 410I to the output coax connector 410O when the face plate 404 is removed to retain continuity of the distribution of the electrical RF signals 310 and power signal 316 distributed through the coupling circuit 500 to downstream components when the face plate 404 is removed, such as during an upgrade. If the coupling circuit 500 could be configured as a make-before-break circuit, the bridge circuit 508 in the face plate 404, which is coupled to the power supply 510, can be configured to couple the input coax connector 410I to the output coax connector 410O as a function of being attached to the base enclosure 406. Legacy coax taps may have coupling circuits that are configured to break a coupling between its input coax port and the output coax port when its face plate is attached, because legacy coax taps typically include a filtering circuit that is configured to couple to an input coax port to filter the electrical RF signals as a signal source (as opposed to optical RF signals from a fiber optic connection like the hybrid fiber/coax tap 300). Then, when the face plate is removed, the coupling circuit is configured to make a connection between its input coax port and the output coax port, before the bridge circuit in the face plate coupling to the input coax port is broken (i.e., make-before-break), to retain continuity of the distribution of the electrical RF signals and power signal between the input and output coax ports. Thus, the face plate 404 of the hybrid fiber/coax tap 300 can be designed with a bridge circuit 508 that is compatible to being attached to a legacy coax tap base enclosure that includes a make-before-break coupling circuit.

FIG. 6 is an exemplary circuit diagram that illustrates more detail of the circuits and function of the hybrid fiber/coax tap 300 in FIGS. 4A-5. In this regard, the hybrid fiber/coax tap 300 includes the input optical port 400I-O, which includes a downlink input optical port 400DI-O configured to be connected to the downlink optical fiber 331D carrying the downlink optical RF signals 328D-O. The hybrid fiber/coax tap 300 also includes an uplink input optical port 400UI-O as part of the input optical port 400I-O that is configured to be connected to the uplink optical fiber 331U carrying the combined uplink optical RF signals 328UC-O. The downlink input optical port 400DI-O is coupled to the O-E converter circuit 504, which is in the form of a photodiode 600 in this example. The O-E converter circuit 504 is configured to convert the downlink optical RF signals 328D-O received from the downlink optical fiber 331D into the downlink electrical RF signals 328D-E. The hybrid fiber/coax tap 300 includes a downlink RF circuit 602D that is coupled to a duplexer circuit 604. For example, the downlink RF circuit 602D may be configured to filter and/or amplifier the downlink electrical RF signals 328D-E. The duplexer circuit 604 distributes the downlink electrical RF signals 328D-E from the O-E converter circuit 504 and the downlink RF circuit 602D to a coupled electrical splitter circuit 606S that is configured to split the downlink electrical RF signals 328D-E into a plurality of downlink electrical RF signals 328D-E each distributed on a coax tap port 402(1)-402(8) to be coupled to a respective subscriber coax cable 332 connected to a coax tap port 402(1)-402(8).

With continuing reference to FIG. 6, the coax tap ports 402(1)-402(8) are configured to receive uplink electrical RF signals 328U-E(1)-328U-E(8) from the respective connected subscriber coax cable 332 connected to the coax tap ports 402(1)-402(8). The coax tap ports 402(1)-402(8) are coupled to an electrical combiner circuit 606C that is configured to combine the plurality of uplink electrical RF signals 328U-E(1)-328U-E(8) into the combined uplink electrical RF signal 328UC-E. The electrical combiner circuit 606C is coupled to the duplexer circuit 604 which distributes the combined uplink electrical RF signal 328UC-E from the electrical combiner circuit 606C to a coupled uplink RF circuit 602U coupled to the E-O converter circuit 506 provide in the form of a laser diode 608 in this example. For example, the uplink RF circuit 602U may be configured to filter and/or amplify the combined uplink electrical RF signal 328UC-E. The E-O converter circuit 506 is configured to convert the combined uplink electrical RF signal 328UC-E to a combined uplink optical RF signal 328UC-O to be distributed over the coupled uplink input optical port 400UI-O to the uplink optical fiber 331U. All of the aforementioned elements and circuits in the hybrid fiber/coax tap 300 in FIG. 6 are part of the face plate 404 of the hybrid fiber/coax tap 300.

With continuing reference to FIG. 6, the base enclosure 406 of the hybrid fiber/coax tap 300 includes the input coax port 408I that includes the input coax connector 410I and the output coax port 408O that includes the output coax connector 410O. The input coax port 408I is configured to be connected to an upstream coax distribution cable 610U carrying the electrical RF signals 310 and the power signal 316. The output coax port 408O is configured to be connected to a downstream coax distribution cable 610D to distribute the electrical RF signals 310 and the power signal 316 received through the bridge circuit 508 as part of the face plate 404 coupling the input coax port 408I to the output coax port 408O. The filter circuit 514 is coupled between the bridge circuit 508 and the power supply 510 and is configured to filter the electrical RF signals 310 to pass the power signal 316 to the power supply 510. The power supply 510 is configured to generate a DC power signal 612 from the power signal 316 that is supplied to at least the O-E converter circuit 504 and the E-O converter circuit 506, and to the downlink RF circuit 602D and uplink RF circuit 602U if they contain any active devices (i.e., non-passive devices) that require power for operation. As previously discussed, the bridge circuit 508 passes the electrical RF signals 310 and power signal 316 from the input coax port 408I to the output coax port 408O to be distributed downstream from the hybrid fiber/coax tap 300 over the downstream coax distribution cable 610D coupled to the output coax port 408O.

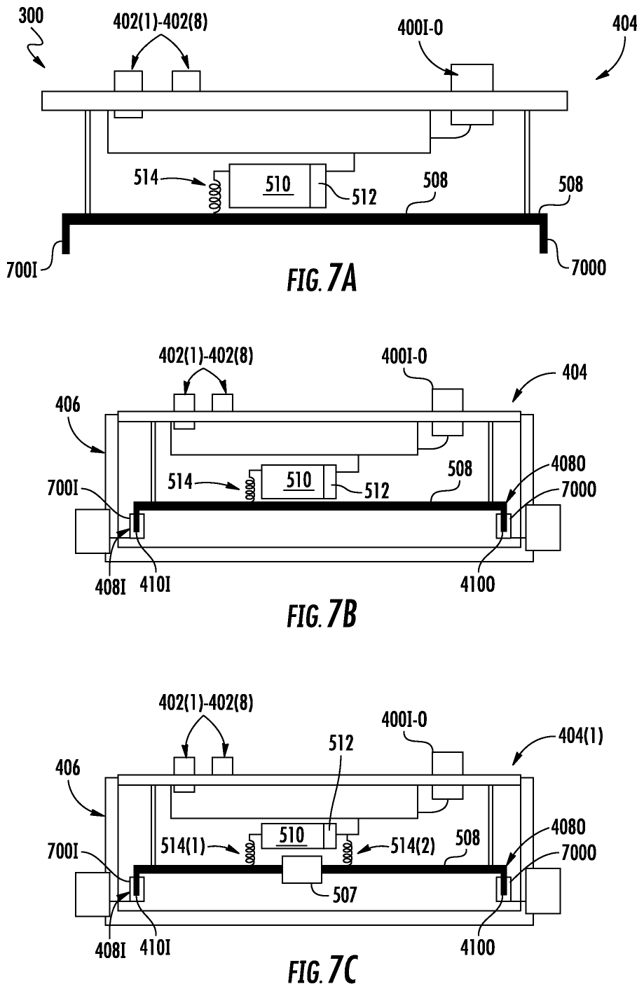

To further illustrate the bridge circuit 508 of the face plate 404 of the hybrid fiber/coax tap 300 and how the bridge circuit 508 is designed to connect the input coax port 408I to the output coax port 408O when attached to the base enclosure 406, FIGS. 7A and 7B are provided. FIG. 7A is a bottom view of the face plate 404 of the hybrid fiber/coax tap 300 in FIGS. 4A-5. FIG. 7B is a bottom view of the face plate 404 installed on the base enclosure 406 of the hybrid fiber/coax tap 300 in FIGS. 4A-5. As shown in FIG. 7A, the bridge circuit 508 is part of the face plate 404. The bridge circuit 508 includes end input and output connectors 700I, 700O (e.g., plugs) that are configured to be automatically be inserted into the respective input coax connector 410I and output coax connector 410O (e.g., receptacles) in the base enclosure 406 when the face plate 404 is attached to the base enclosure 406, as shown in FIG. 7B. In this manner, if the base enclosure 406 is equipped with a coupling circuit 500 (see FIG. 5) that is configured to break a connection between the input coax connector 410I and the output coax connector 410O when the face plate 404 is attached to the base enclosure 406, the bridge circuit 508 as part of the face plate 404 will connect the input coax connector 410I and output coax connector 410O to retain the distribution of the electrical RF signals 310 and power signal 316 from the input coax connector 410I to the output coax connector 410O and to the downstream coax distribution cable 610D coupled to the output coax port 408O. In this regard, the face plate 404 of the hybrid fiber/coax tap 300 is compatible with legacy coax taps that include the coupling circuit 500.

The hybrid fiber/coax tap 300 in FIGS. 4A-5 includes the input optical port 400I-O that is configured to be connected to a fiber optic distribution cable 330 (see FIG. 3) to receive the downlink optical RF signals 328D-O and to receive the combined uplink optical RF signals 328UC-O from the coax tap ports 402(1)-402(8). The downlink optical RF signals 328D-O terminate at the hybrid fiber/coax tap 300. Likewise, the combined uplink optical RF signals 328UC-O are only passed back to the input optical port 400I-O and are not passed to downstream connected components of the hybrid fiber/coax tap 300. Thus, the hybrid fiber/coax tap 300 in FIGS. 4A-5 facilitates a point-to-point fiber optic connection. However, it may be desired to provide a hybrid fiber-coax tap that supports a point-to-multipoint fiber optic connectivity where the tap serves to continue the distribution of the downlink optical RF signals 328D-O to downstream connected taps, and can distribute the combined uplink optical RF signals 328UC-O to other upstream taps.

FIG. 7C is a bottom view of the face plate 404(1) of the hybrid fiber/coax tap 300 in FIGS. 4A-5, and employing an optional RF attenuator 507 to attenuate the electrical RF signals 310 from the input coax connector 410I or output coax connector 410O by a given dB level based on the design of the RF attenuator 507. It may be desired to attenuate the electrical RF signals 310 in the hybrid fiber/coax tap 300. Common components between the face plate 404 in FIG. 7A and the face plate 404(1) in FIG. 7C are shown with common element numbers, and will not be re-described. In this regard, the RF attenuator 507 is coupled inline to the bridge circuit 508. Two filter circuits 514(1), 514(2), such as RF chokes for example, are coupled in parallel to the RF attenuator 507 and the power supply 510.

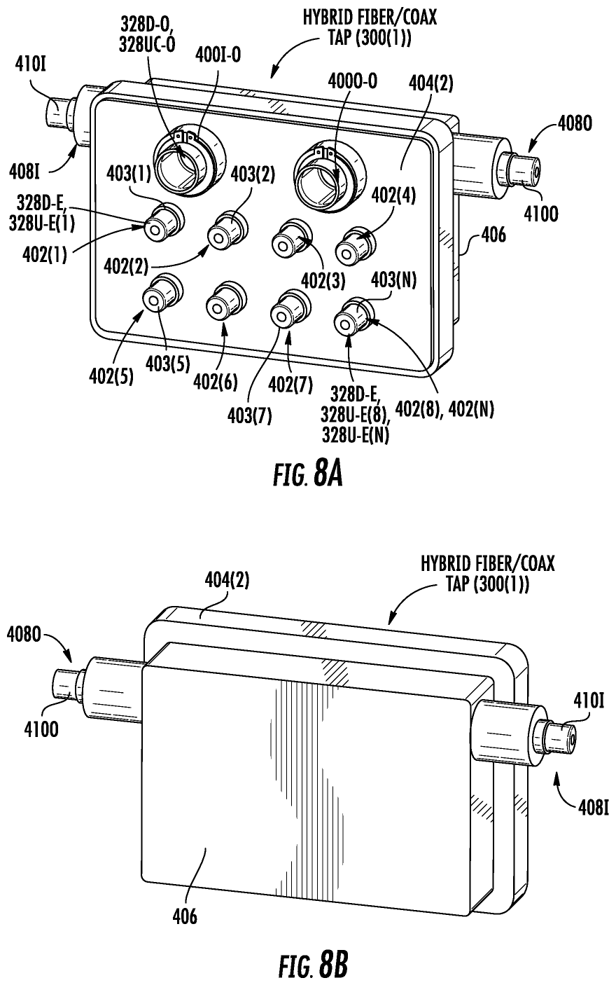

FIGS. 8A and 8B are front perspective and rear perspective views, respectively, of an alternative hybrid fiber/coax tap 300(1) with a face plate 404(2) that additionally includes an output optical port 400O-O. The hybrid fiber/coax tap 300(1) is configured to pass the received downlink optical RF signals 328D-O on the input optical port 400I-O, to the output optical port 400O-O that can be coupled to another downstream fiber tap in a daisy-chain connectivity with the downstream fiber tap. In this manner, an additional fiber optic distribution cable is not required to supply the downlink optical RF signals 328D-O to the downstream fiber tap. Also, the hybrid fiber/coax tap 300(1) is configured to pass the combined uplink optical RF signals 328UC-O to not only the input optical port 400I-O, but also the output optical port 400O-O that can be coupled to another upstream fiber tap in a daisy-chain connectivity with an the upstream fiber tap. This functionality of the hybrid fiber/coax tap 300(1) allows a point-to-multipoint configuration in a network employing the hybrid fiber/coax tap 300(1). Common components between the hybrid fiber/coax tap 300(1) in FIGS. 8A and 8B and the hybrid fiber/coax tap 300 in FIGS. 4A-4C are shown with common element numbers in FIGS. 8A and 8B, and will not be re-described.

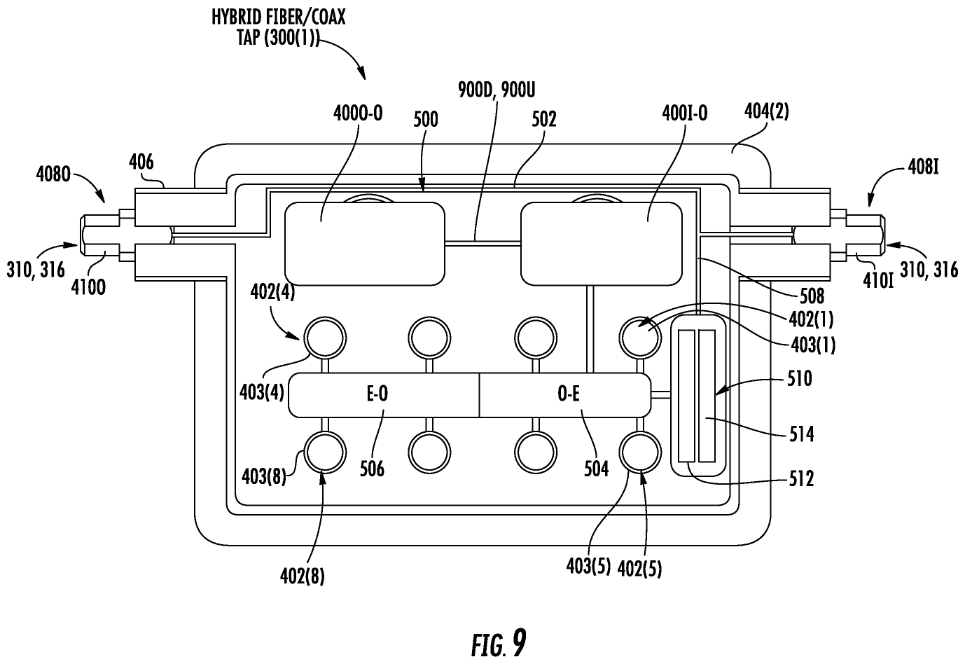

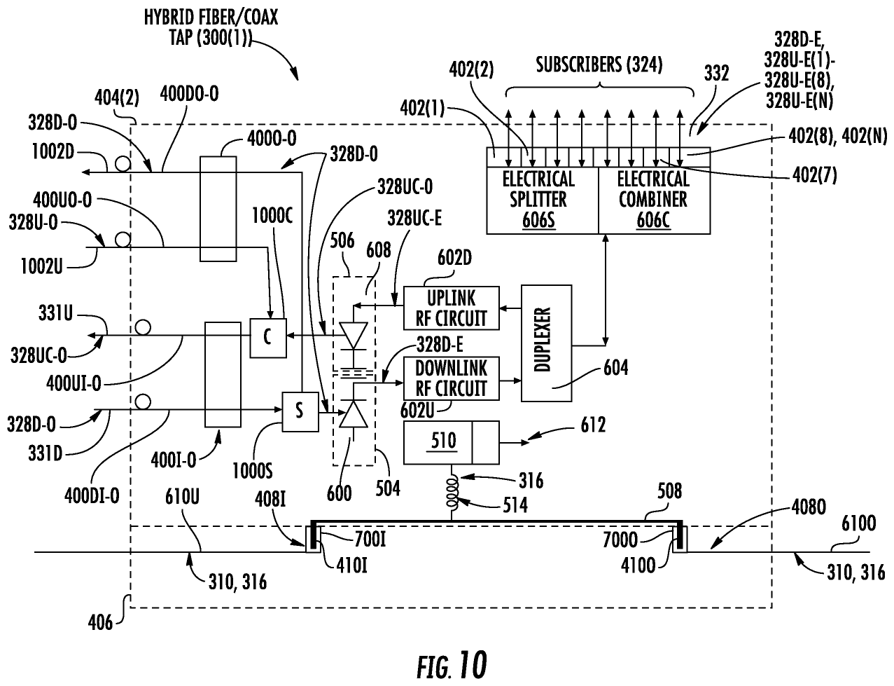

FIG. 9 is a rear view of the hybrid fiber/coax tap 300(1) in FIGS. 8A and 8B with the internal components shown. The hybrid fiber/coax tap 300(1) includes the face plate 404(2) that is removably attached to the same base enclosure 406 as provided in the hybrid fiber/coax tap 300 in FIGS. 4A-5. Common components between the hybrid fiber/coax tap 300(1) in FIG. 9 and the hybrid fiber/coax tap 300 in FIG. 5 are shown with common element numbers in FIG. 5, and will not be re-described. As shown in FIG. 9, the hybrid fiber/coax tap 300(1) also includes the output optical port 400O-O. As will be described in more detail below, the input optical port 400I-O and the output optical port 400O-O are optically connected to each other between internal uplink and downlink fibers 900U, 900D.

FIG. 10 is an exemplary circuit diagram that illustrates more detail of the circuits and function of the hybrid fiber/coax tap 300(1) in FIGS. 8A-9. Common components between the circuit diagram of the hybrid fiber/coax tap 300(1) in FIG. 10 and the circuit diagram of the hybrid fiber/coax tap 300 in FIG. 6 are shown with common element numbers between FIGS. 10 and 6, and will not be re-described. As shown in FIG. 10, the face plate 404(2) of the hybrid fiber/coax tap 300(1) includes a downlink optical splitter circuit 1000S and an uplink optical combiner circuit 1000C. The downlink optical splitter circuit 1000S is coupled to the downlink input optical port 400DI-O, the O-E converter circuit 504, and the downlink output optical port 400DO-O. The downlink optical splitter circuit 1000S is configured to split the downlink optical RF signal 328D-O received on the downlink input optical port 400DI-O to the downlink output optical port 400DO-O and to a downlink optical fiber 1002D connected to the downlink output optical port 400DO-O. The downlink optical fiber 1002D may be part of a fiber optic distribution cable. In this manner, the hybrid fiber/coax tap 300(1) facilitates splitting and passing the downlink optical RF signal 328D-O to a connected downstream fiber tap or other fiber component in a daisy-chain configuration.

The face plate 404(2) of the hybrid fiber/coax tap 300(1) also includes the uplink optical combiner circuit 1000C. The uplink optical combiner circuit 1000C is coupled to the uplink input optical port 400UI-O, the E-O converter circuit 506, and the uplink output optical port 400UO-O. The uplink optical combiner circuit 1000C is configured to combine the combined uplink optical RF signals 328UC-O with the received uplink optical RF signal 328U-O received on the uplink output optical port 400UO-O to be distributed on the uplink input optical port 400UI-O, also to the uplink output optical port 400UO-O and to an uplink optical fiber 1002U connected to the uplink output optical port 400UO-O. The uplink optical fiber 1002U may be part of the same fiber optic distribution cable as the downlink optical fiber 1002D. In this manner, the hybrid fiber/coax tap 300(1) facilitates passing other combined uplink optical RF signals along with combined uplink optical RF signal 328UC-O to a connected upstream fiber tap or other fiber component in a daisy-chain configuration.

The hybrid fiber/coax tap 300(1) in FIGS. 8A-10 includes the additional downlink optical splitter circuit 1000S and the uplink optical combiner circuit 1000C to support daisy-chain connection of the hybrid fiber/coax tap 300(1) to other downstream and/or upstream connected fiber taps. However, the same splitting and combining functionality can also be performed electrically in a hybrid fiber/coax tap to facilitate passing the downlink optical RF signal 328D-O to a connected downstream fiber tap or other fiber component in a daisy-chain configuration, and passing other combined uplink optical RF signals along with the combined uplink optical RF signal 328UC-O to a connected upstream fiber tap or other fiber component in a daisy-chain configuration.

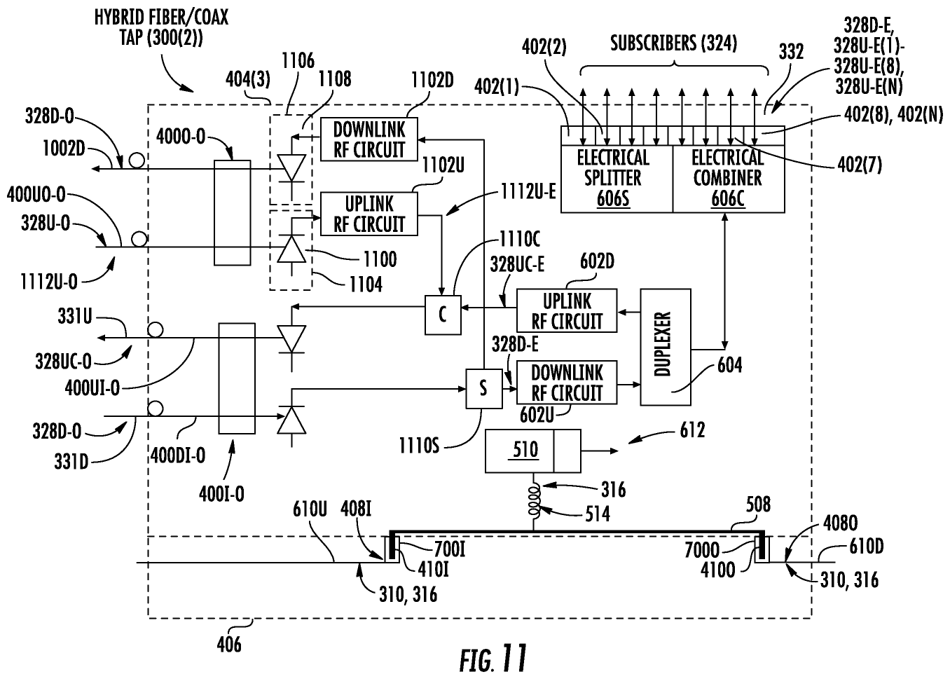

In this regard, FIG. 11 is an exemplary circuit diagram that illustrates more detail of the circuits and function of another hybrid fiber/coax tap 300(2) that can be employed as the hybrid fiber/coax tap 300(1) in FIGS. 8A-9. Common components between the circuit diagram of the hybrid fiber/coax tap 300(2) in FIG. 11 and the circuit diagram of the hybrid fiber/coax tap 300(1) in FIG. 10 are shown with common element numbers between FIGS. 10 and 11, and will not be re-described. As shown in FIG. 11, a face plate 404(3) of the hybrid fiber/coax tap 300(2) includes a downlink RF splitter circuit 1110S and an uplink RF combiner circuit 1110C. The downlink RF splitter circuit 1110S is coupled to the E-O converter circuit 506 and to the downlink output optical port 400DO-O. The downlink RF splitter circuit 1110S is configured to split the downlink electrical RF signal 328D-E converted into an electrical signal by the E-O converter circuit 506 into the downlink optical RF signal 328D-O to a downlink RF circuit 1102D, which is coupled to a downlink E-O converter circuit 1106 in the form of a laser diode 1108. The downlink E-O converter circuit 1106 is configured to convert the downlink electrical RF signal 328D-E back into an optical RF signal as the downlink optical RF signal 328D-O on the downlink output optical port 400DO-O. In this manner, the splitting of the downlink optical RF signal 328D-O is performed in the electrical domain instead of the optical domain like in the hybrid fiber/coax tap 300(1) in FIGS. 8A-9. However, this requires an additional E-O converter circuit, namely the downlink E-O converter circuit 1106.

Similarly, the face plate 404(3) of the hybrid fiber/coax tap 300(2) also includes the uplink RF combiner circuit 1110C. The uplink RF combiner circuit 1110C is coupled to the E-O converter circuit 506, the uplink RF circuit 602U, and an uplink RF circuit 1102U, which is coupled to an uplink O-E converter circuit 1100 in the form of a photodiode 1104 coupled to the uplink output optical port 400UO-O. The uplink O-E converter circuit 1100 is configured to receive an uplink optical RF signal 1112U-O from the uplink output optical port 400UO-O and convert the uplink optical RF signal 1112U-O into an uplink electrical RF signal 1112U-E coupled to the uplink RF circuit 1102U and the uplink RF combiner circuit 1110C. The uplink RF combiner circuit 1110C is configured to combine the uplink electrical RF signal 1112U-E with the combined uplink electrical RF signal 328UC-E to be provided to the E-O converter circuit 506. The combined uplink electrical RF signal 328UC-E and uplink electrical RF signal 1112U-E are coupled to the uplink input optical port 400UI-O. In this manner, the combining of the combined uplink optical RF signal 328UC-O with received uplink optical RF signal 1112U-O from an upstream fiber component from the uplink output optical port 400UO-O is performed in the electrical domain instead of the optical domain like in the hybrid fiber/coax tap 300(1) in FIGS. 8A-9. However, this requires an additional E-O converter circuit, namely the uplink O-E converter circuit 1100.

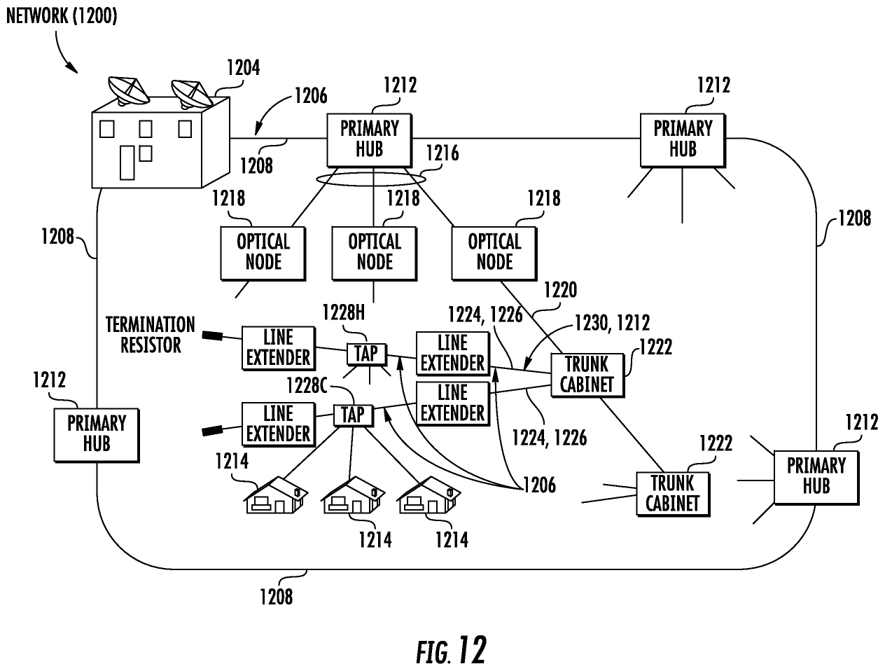

FIG. 12 is a schematic diagram of an exemplary network 1200 that can employ hybrid fiber/coax taps, including but not limited to the hybrid fiber/coax taps 300, 300(1), 300(2) in FIGS. 4A-11, to distribute communications and/or data signals via fiber optic cable to the hybrid fiber/coax taps connected to subscribers. The network 1200 may be a CATV network that distributes CATV signals an example. In this regard, this network 1200 includes a head-end switch 1204 that is configured to distribute optical signals 1206 over a fiber optic feeder cable 1208. In this example, the fiber optic feeder cable 1208 is a ring. The benefits of optical fiber are well known and include higher signal-to-noise ratios and increased bandwidth. The optical signals may then be carried over the fiber optic feeder cables 1208 to a hub 1212, which may be local convergence points (LCPs). The hubs 1212 act as consolidation points for splicing and making cross-connections and interconnections, as well as providing locations for optical couplers and splitters. The optical couplers and splitters in the hubs 1212 enable a single optical fiber to serve multiple subscribers 1214. Typical premises of subscribers 1214 include single-dwelling units (SDU), multi-dwelling units (MDU), businesses, and/or other facilities or buildings. Fiber optic cables 1216, such as distribution cables, exit the hubs 1212 to carry optical signals 1206 to optical nodes 1218. A fiber optic trunk cable 1220 is connected between an optical node 1218 and a trunk cabinet 1222. Fiber optic and coax cables 1224, 1226 exit the trunk cabinet 1222 where the fiber optic cables 1224 carry the optical signals 1206, and the coax cables 1226 carry electrical RF signals 1230 and a power signal 1232 for the network 1200. A hybrid fiber/coax tap 122811 can be connected to the fiber optic and coax cables 1224, 1226 to receive the optical signals 1206 for tapping to the subscribers 1214 as previously discussed, and the electrical RF signals 1230 and the power signal 1232. A coax tap 1228C that does not support fiber optic connectivity can be connected to the coax cable 1226 to receive the electrical RF signals 1230 for tapping to the subscribers 1214, and the power signal 1232.

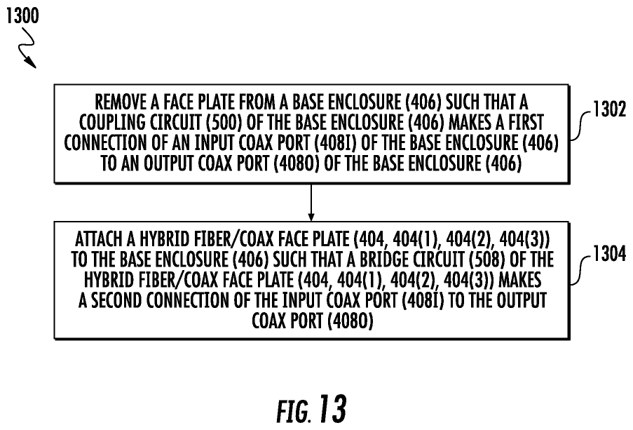

As previously discussed, the hybrid fiber/coax taps 300, 300(1), 300(2) in FIGS. 4A-11 include respective face plates 404, 404(1), 404(2), 404(3) that are configured to be attached to the base enclosure 406 such that the face plates 404, 404(1), 404(2), 404(3) can be attached to legacy coax tap base enclosures to upgrade such coax taps to hybrid fiber/coax taps. In this regard, FIG. 13 is a flowchart illustrating an exemplary process 1300 of installing a hybrid fiber/coax tap, such as hybrid fiber/coax taps 300, 300(1), 300(2) in FIGS. 4A-11, in a network, such as network 1200 in FIG. 12, by converting an existing coax tap connected into the network to a hybrid fiber/coax tap. The exemplary process 1300 is applicable to any of the hybrid fiber/coax taps 300, 300(1), 300(2) in FIGS. 4A-11. In this regard, a first step in the process 1300 is removing a face plate from the base enclosure 406 such that the coupling circuit 500 of the base enclosure 406 makes a first connection of the input coax port 408I of the base enclosure 406 to the output coax port 408O of the base enclosure 406 (block 1302). As previously discussed, the base enclosure 406 may include the coupling circuit 500 that is configured to have a make-before-break functionality such that as the face plate is removed, the coupling circuit 500 making the first connection of the input coax port 408I of the base enclosure 406 to the output coax port 408O of the base enclosure 406 to retain the continuity of the electrical RF signals 310 and power signal 316 being coupled from the input coax port 408I to the output coax port 408O to facilitate connection of downstream taps. A next step in the exemplary process 1300 in FIG. 13 is attaching a hybrid fiber/coax face plate 404, 404(1), 404(2), or 404(3) to the base enclosure 406 such that the bridge circuit 508 of the hybrid fiber/coax face plate 404, 404(1), 404(2), or 404(3) makes a second connection of the input coax port 408I to the output coax port 408O (block 1304). Attaching the hybrid fiber/coax face plate 404, 404(1), 404(2), or 404(3) to the base enclosure 406 may also cause the disconnection of the first connection of the input coax port 408I of the base enclosure 406 from the output coax port 408O of the base enclosure 406 through the coupling circuit 500, as previously described. As previously discussed, the coupling circuit 500 may be configured to disconnect the first connection of the input coax port 408I of the base enclosure 406 from the output coax port 408O when a face plate, including the hybrid fiber/coax face plate 404, 404(1), 404(2), or 404(3), is attached to the base enclosure 406.

Coupling as discussed herein can be a direct physical connection or a direct or indirect electrical coupling. Elements can be electrically coupled together through intermediate coupled or connected elements. The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A hybrid fiber/coaxial (coax) tap, comprising:
a downlink input optical port configured to be connected to a downlink optical fiber carrying an optical radio frequency (RF) signal;
an uplink input optical port;
an optical-to-electrical (O-E) converter circuit coupled to the downlink input optical port, the O-E converter circuit configured to convert a downlink optical RF signal into a downlink electrical RF signal;
a plurality of coax tap ports;
an electrical splitter circuit coupled to the O-E converter circuit and the plurality of coax tap ports, the electrical splitter circuit configured to split the downlink electrical RF signal into a plurality of the downlink electrical RF signals each distributed on a coax tap port among the plurality of coax tap ports;
an electrical combiner circuit coupled to the plurality of coax tap ports and an electrical-to-optical (E-O) converter circuit, the electrical combiner circuit configured to combine a plurality of uplink electrical RF signals received on the plurality of coax tap ports into a combined uplink electrical RF signal;
the E-O converter circuit coupled to the electrical combiner circuit and the uplink input optical port, the E-O converter circuit configured to convert the combined uplink electrical RF signal to a combined uplink optical RF signal;
the uplink input optical port configured to receive the combined uplink optical RF signal;
an input coax port configured to be connected to an upstream coax distribution cable carrying an electrical RF signal and a power signal;
an output coax port coupled to the input coax port and configured to be connected to a downstream coax distribution cable to distribute the electrical RF signal and the power signal to the downstream coax distribution cable; and
a filter circuit coupled to the input coax port, the O-E converter circuit, and the E-O converter circuit, the filter circuit configured to filter the electrical RF signal to couple the power signal to the O-E converter circuit and the E-O converter circuit.

2. The hybrid fiber/coax tap of claim 1, wherein:
the input coax port is further configured to receive the electrical RF signal from the downstream coax distribution cable;
the output coax port is further configured to distribute the electrical RF signal to the downstream coax distribution cable; and
the filter circuit is further configured to filter out the electrical RF signal received on the input coax port.

3. The hybrid fiber/coax tap of claim 1, further comprising a coupling circuit coupling the input coax port to the output coax port.

4. The hybrid fiber/coax tap of claim 1, further comprising a bridge circuit coupled to the input coax port, wherein the filter circuit is coupled to the bridge circuit.

5. The hybrid fiber/coax tap of claim 1, wherein the power signal comprises an alternating current (AC) power signal; and
further comprising an AC to direct current (DC) (AC-DC) converter circuit coupled to the filter circuit, the AC-DC converter circuit configured to convert the power signal to a DC power signal.

6. The hybrid fiber/coax tap of claim 1, further comprising a duplexer circuit coupled to the electrical splitter circuit, the electrical combiner circuit, the O-E converter circuit, and the E-O converter circuit, the duplexer circuit configured to:
distribute the downlink electrical RF signal from the O-E converter circuit to the electrical splitter circuit; and
distribute the combined uplink electrical RF signal from the electrical combiner circuit to the E-O converter circuit.

7. The hybrid fiber/coax tap of claim 1, wherein the O-E converter circuit comprises a photodiode circuit.

8. The hybrid fiber/coax tap of claim 1, wherein the E-O converter circuit comprises a laser diode circuit.

9. The hybrid fiber/coax tap of claim 1, further comprising:
a downlink output optical port;
an uplink output optical port configured to be connected to an uplink optical fiber carrying an uplink optical RF signal;
a downlink optical splitter circuit coupled to the downlink input optical port, the O-E converter circuit, and the downlink output optical port;
an uplink optical combiner circuit coupled to the uplink output optical port, the E-O converter circuit, and the uplink input optical port;
the downlink optical splitter circuit configured to split the downlink optical RF signal received on the downlink input optical port to the downlink output optical port; and
the uplink optical combiner circuit configured to combine the combined uplink optical RF signal with the uplink optical RF signal from the uplink output optical port to the uplink input optical port.

10. The hybrid fiber/coax tap of claim 1, further comprising:
a downlink output optical port;
an uplink output optical port configured to be connected to an uplink optical fiber carrying an uplink optical RF signal;
a downlink E-O converter circuit coupled to the downlink output optical port;
an uplink O-E converter circuit coupled to the uplink output optical port and configured to convert the uplink optical RF signal to an uplink electrical RF signal;
a downlink RF splitter circuit coupled to the downlink E-O converter circuit and the electrical splitter circuit;
an uplink RF combiner circuit coupled to the uplink O-E converter circuit and the electrical combiner circuit;
the downlink RF splitter circuit configured to split the downlink electrical RF signal received from the O-E converter circuit to the downlink E-O converter circuit; and
the uplink RF combiner circuit configured to combine the combined uplink electrical RF signal with the uplink electrical RF signal to the E-O converter circuit.

11. A hybrid fiber/coaxial (coax) tap, comprising:
a base enclosure; and
a face plate configured to be removably attached to the base enclosure;
the base enclosure comprising:
an input coax port;
an output coax port; and
a coupling circuit configured to couple the input coax port to the output coax port when the face plate is detached from the base enclosure; and
the face plate comprising:
a downlink input optical port;
an uplink input optical port;
an optical-to-electrical (O-E) converter circuit coupled to the downlink input optical port;
a plurality of coax tap ports;
an electrical splitter circuit coupled to the O-E converter circuit and the plurality of coax tap ports;
an electrical combiner circuit coupled to the plurality of coax tap ports and an electrical-to-optical (E-O) converter circuit;
the E-O converter circuit coupled to the electrical combiner circuit and the uplink input optical port;
a filter circuit coupled to the O-E converter circuit and the E-O converter circuit; and
a bridge circuit coupled to the filter circuit, the bridge circuit configured to be coupled to the input coax port and the output coax port when the face plate is attached to the base enclosure.

12. The hybrid fiber/coax tap of claim 11, wherein:
the input coax port is configured to be connected to an upstream coax distribution cable carrying a power signal and an electrical radio frequency (RF) signal;
an output coax port is configured to be connected to a downstream coax distribution cable to distribute the power signal and the electrical RF signal to the downstream coax distribution cable; and
the coupling circuit is configured to couple the power signal and the electrical RF signal received on the input coax port to the output coax port when the face plate is detached from the base enclosure.

13. The hybrid fiber/coax tap of claim 11, wherein:
the O-E converter circuit is configured to convert a downlink optical radio frequency (RF) signal on the downlink input optical port into a downlink electrical RF signal;
the electrical splitter circuit is configured to split the downlink electrical RF signal into a plurality of downlink electrical RF signals each distributed on a coax tap port among the plurality of coax tap ports;
the bridge circuit is configured to couple an electrical RF signal and a power signal on the input coax port to the filter circuit when the face plate is attached to the base enclosure; and
the filter circuit is configured to filter the electrical RF signal from the bridge circuit to couple the power signal to the O-E converter circuit.

14. The hybrid fiber/coax tap of claim 11, wherein:
the electrical combiner circuit is configured to combine a plurality of uplink electrical radio frequency (RF) signals received on the plurality of coax tap ports into a combined uplink electrical RF signal;
the E-O converter circuit is configured to convert the combined uplink electrical RF signal to a combined uplink optical RF signal on the uplink input optical port;
the bridge circuit is further configured to couple the electrical RF signal and the power signal on the input coax port to the filter circuit when the face plate is attached to the base enclosure; and
the filter circuit configured to filter an electrical RF signal from the bridge circuit to couple a power signal to the E-O converter circuit.

15. The hybrid fiber/coax tap of claim 11, wherein the face plate further comprises:
a downlink output optical port;
an uplink output optical port;
a downlink optical splitter circuit coupled to the downlink input optical port, the O-E converter circuit, and the downlink output optical port; and
an uplink optical combiner circuit coupled to the uplink input optical port, the E-O converter circuit, and the uplink output optical port.

16. The hybrid fiber/coax tap of claim 15, wherein:
the downlink optical splitter circuit is configured to split a downlink optical radio frequency (RF) signal received on the downlink input optical port to the downlink output optical port; and
the uplink optical combiner circuit is configured to combine a combined uplink optical RF signal from the E-O converter circuit with an uplink optical RF signal from the uplink output optical port to the uplink input optical port.

17. The hybrid fiber/coax tap of claim 11, wherein the face plate further comprises:
a downlink output optical port;
an uplink output optical port configured to be connected to an uplink optical fiber carrying an uplink optical radio frequency (RF) signal;
a downlink E-O converter circuit coupled to the downlink output optical port;
an uplink O-E converter circuit coupled to the uplink output optical port;
a downlink RF splitter circuit coupled to the downlink E-O converter circuit and the electrical splitter circuit; and
an uplink RF combiner circuit coupled to the uplink O-E converter circuit and the electrical combiner circuit.

18. The hybrid fiber/coax tap of claim 17, wherein:
the uplink O-E converter circuit is configured to convert an uplink optical RF signal on the uplink output optical port to an uplink electrical RF signal;
the downlink RF splitter circuit is configured to split a downlink electrical RF signal received from the O-E converter circuit to the downlink E-O converter circuit; and
the uplink RF combiner circuit is configured to combine a combined uplink electrical RF signal from the electrical splitter circuit with the uplink electrical RF signal to the E-O converter circuit.

19. A network, comprising:
at least one coaxial (coax) tap each comprising:
an input coax port configured to be connected to an upstream coax distribution cable carrying a power signal and an electrical radio frequency (RF) signal;
an output coax port configured to be connected to a downstream coax distribution cable; and
a plurality of coax tap ports;
the at least one coax tap configured to distribute the electrical RF signal to the plurality of coax tap ports and distribute the power signal and the electrical RF signal from the input coax port to the output coax port; and
at least one hybrid fiber/coax tap each comprising:
a base enclosure; and
a hybrid fiber/coax face plate configured to be removably attached from the base enclosure;
the base enclosure comprising:
a second input coax port configured to be connected to a second upstream coax distribution cable carrying the power signal and the electrical RF signal;
a second output coax port configured to be connected to a second downstream coax distribution cable; and
a coupling circuit configured to couple the second input coax port to the second output coax port to and distribute the power signal and the electrical RF signal from the second input coax port to the second output coax port when the hybrid fiber/coax face plate is detached from the base enclosure; and
the hybrid fiber/coax face plate comprising:
a downlink input optical port;
an uplink input optical port;
an optical-to-electrical (O-E) converter circuit coupled to the downlink input optical port;
a plurality of second coax tap ports;
an electrical splitter circuit coupled to the O-E converter circuit and the plurality of second coax tap ports;
an electrical combiner circuit coupled to the plurality of second coax tap ports and an electrical-to-optical (E-O) converter circuit;
the E-O converter circuit coupled to the electrical combiner circuit and the uplink input optical port;
a filter circuit coupled to the O-E converter circuit and the E-O converter circuit; and
a bridge circuit coupled to the filter circuit, the bridge circuit configured to be coupled to the second input coax port to the second output coax port when the face plate is attached to the base enclosure.

20. The network of claim 19, wherein the hybrid fiber/coax face plate of the at least one hybrid fiber/coax tap further comprises:
a downlink output optical port;
an uplink output optical port;
a downlink optical splitter circuit coupled to the downlink input optical port, the O-E converter circuit, and the downlink output optical port; and
an uplink optical combiner circuit coupled to the uplink input optical port, the E-O converter circuit, and the uplink output optical port.
